(19) United States
(12) Patent Application Publication
(10) Pub. No.: US 2016/0163081 A1
(43) Pub. Date: Jun. 9, 2016

(54) SERVER AND METHOD FOR GENERATING SLIDE SHOW THEREOF

(71) Applicant: Samsung Electronics Co., Ltd., Suwon-si (KR)

(72) Inventors: Du-seok KIM, Yongin-si (KR); Si-jun LEE, Suwon-si (KR); Il-kang NA, Seoul (KR); Hyun-cheol PARK, Suwon-si (KR); Cheol-ju HWANG, Yongin-si (KR)

(21) Appl. No.: 14/953,192

(22) Filed: Nov. 27, 2015

(30) Foreign Application Priority Data
Dec. 8, 2014 (KR) 10-2014-0175085

(51) Int. Cl. G06T 11/60; G06F 17/21; H04L 29/06; G06F 17/24

(52) U.S. Cl. CPC G06T 11/60; G06F 17/24; G06F 17/212; H04L 67/42

(57) ABSTRACT

A server is provided. The server includes a communication interface configured to perform communication with a plurality of user terminals, a storage configured to receive and store contents through the communication interface, the contents being transmitted from the plurality of user terminals, and a processor configured to, in response to a command to generate a slide show for sequentially displaying a plurality of slide images being received from a first user terminal that is one of the plurality of user terminals, generate the slide show by combining a target content of the first user terminal and a related content which is related to the target content from among the contents stored in the storage.

### CROSS-REFERENCE TO RELATED APPLICATION(S)

This application claims the benefit under 35 U.S.C. §119(a) of a Korean patent application filed on Dec. 8, 2014 in the Korean Intellectual Property Office and assigned Serial No. 10-2014-0175085, the entire disclosure of which is hereby incorporated by reference.

### TECHNICAL FIELD

The present disclosure relates to a server and a method for generating a slide show thereof. More particularly, the present disclosure relates to a server which generates a slide show by using content of a user terminal and content which is related to the content of the user terminal and provides the user terminal with the slide show.

### BACKGROUND

With the development of electronic technologies, a personal terminal device provides diverse service. For example, a user is able to record various activities, such as those when on a trip or during the user's daily life, through a terminal device such as a smart phone.

Such a record might be generated as a slide show through a service provided by an application of a user terminal or by an external server. A slide show refers to an operation of sequentially displaying a plurality of slide images in a display apparatus.

However, in the related art, only the contents of a user may be used to generate a slide show. Thus, when there are a small number of photos that a user took during a trip, the photos are not enough to generate a slide show. In addition, when the user wishes to watch other users' photos in the form of a slide show along with his/her own photos, the users need to exchange the photos using an electronic mail and generate a slide show respectively.

Accordingly, much effort is needed by the user to generate a slide show having abundant information.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a server which generates a slide show by using a contents of a user terminal and a related content which is related to the content of the user terminal and provides the user terminal with the slide show.

In accordance with an aspect of the present disclosure, a server is provided. The server includes a communication interface configured to perform communication with a plurality of user terminals, a storage configured to receive and store contents through the communication interface, the contents being transmitted from the plurality of user terminals, and a processor configured to, in response to a command to generate a slide show for sequentially displaying a plurality of slide images being received from a first user terminal that is one of the plurality of user terminals, generate the slide show by combining a target content of the first user terminal and a related content which is related to the target content from among the contents stored in a storage.

In response to period-designation information being received from the first user terminal, the processor may determine a content generated or uploaded in the first user terminal during a period corresponding to the period-designation information from among contents transmitted from the first user terminal as the target content.

In response to the period-designation information and moving route information being received from the first user terminal, the processor may generate the slide show by additionally including a content related to a moving route where the first user terminal moves during a period corresponding to the period-designation information from among the contents stored in the storage.

The processor may determine the related content from among the contents stored in the storage based on at least one piece of information on the target content. In addition, the at least one piece of information may include at least one of information on text included in the target content, information on an image included in the target content, information on a time when the target content is generated or uploaded, and information on a location where the target content is generated or uploaded.

In response to the target content being a photo content, the processor may determine a content corresponding to information on at least one of an object, a figure, and a background included in the photo content as the related content.

In response to text being included in the target content, the processor may extract a keyword from the text and determine a content corresponding to the extracted keyword as the related content.

The processor may determine a content being generated in the location where the target content is generated and at a time in a predetermined range with respect to the time when the target content is generated as the related content based the information on the location where the target content and the time when the target content is generated.

The processor may generate the slide show so that background music corresponding to the information on a location where at least one content constituting the slide show is generated and the keyword extracted from text included in the at least one content is played back concurrently with the slide show.

The communication interface may communicate with an external server. In addition, the processor may retrieve a content related to the target content from the external server by using information on the target content and generate the slide show by additionally including the retrieved content.

The server may be a server which provides a social network service (SNS). In addition, the contents stored in the storage may be contents that users of the plurality of user terminals upload to the server through the SNS.

In accordance with another aspect of the present disclosure, a method for generating a slide show of a server is provided. The method includes receiving and storing contents transmitted from a plurality of user terminals, receiving a command to generate a slide show for sequentially displaying a plurality of slide images from a first user terminal that is one of the plurality of user terminals, and generating the slide show by combining a target content of the first user terminal and a related content which is related to the target content from among pre-stored contents.

In response to period-designation information being received from the first user terminal, the generating of the slide show may include determining a content generated or uploaded in the first user terminal during a period corresponding to the period-designation information from among the contents transmitted from the first user terminal as the target content.

The period-designation information and moving route information being received from the first user terminal, the generating of the slide show may include generating the slide show by additionally including a content related to a moving route where the first user terminal moves during a period corresponding to the period-designation information from among the pre-stored contents.

The generating of the slide show may include determining the related content from among the pre-stored contents based on at least one piece of information on the target content. In addition, the at least one piece of information may include at least one of information on text included in the target content, information on an image included in the target content, information on a time when the target content is generated or uploaded, and information on a location where the target content is generated or uploaded.

In response to the target content being a photo content, the generating of the slide show may include determining a content corresponding to information on at least one of an object, a figure, and a background included in the photo content as the related content.

In response to text being included in the target content, the generating of the slide show may include extracting a keyword from the text and determining a content corresponding to the extracted keyword as the related content.

The generating of the slide show may include determining a content being generated in the location where the target content is generated and at a time in a predetermined range with respect to the time when the target content is generated as the related content based the information on the location where the target content and the time when the target content is generated.

The generating of the slide show may include generating the slide show so that background music corresponding to the information on a location where at least one content constituting the slide show is generated and the keyword extracted from text included in the at least one content is played back concurrently with the slide show.

The generating of the slide show may include retrieving a content related to the target content from the external server by using information on the target content and generating the slide show by additionally including the retrieved content.

In accordance with another aspect of the present disclosure, a computer-readable recording medium including a program for executing a method for generating a slide show of a server is provided. The method includes receiving and storing contents transmitted from a plurality of user terminals, receiving a command to generate a slide show for sequentially displaying a plurality of slide images from a first user terminal that is one of the plurality of user terminals, and generating the slide show by combining a target content of the first user terminal and an related content which is related to the target content.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view provided to describe a slide show providing service system according to an embodiment of the present disclosure;

FIG. 2 is a block diagram illustrating a structure of a server according to an embodiment of the present disclosure;

FIGS. 3, 4, 5, 6, and 7 are views provided to describe a method for generating a slide show according to various embodiments of the present disclosure;

FIG. 8 is a sequence diagram provided to describe a method for generating a slide show of a server according to an embodiment of the present disclosure;

FIGS. 9 and 10 are views illustrating various user interface (UI) screens which may be displayed in a user terminal according to various embodiments of the present disclosure;

FIG. 11 is a flowchart provided to describe a method for generating a slide show according to an embodiment of the present disclosure;

FIG. 12 is a view provided to describe a slide show which is generated according to an embodiment of the present disclosure;

FIG. 13 is a block diagram illustrating a structure of a user terminal according to an embodiment of the present disclosure; and

FIG. 14 is a sequence diagram provided to describe a method for generating a slide show of a user terminal according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the present disclosure, relational terms, such as ‘first’ and ‘second,’ may be used to distinguish one entity from another entity, without necessarily implying any actual relationship or order between such entities.

The terms, such as ‘include,’ ‘comprise,’ ‘configured to,’ in the description are used to indicate that there are features, numbers, steps, operations, elements, parts or combination thereof, and they should not exclude the possibilities of combination or addition of one or more features, numbers, steps, operations, elements, parts or combination thereof.

In an embodiment of the present disclosure, a ‘module’ or a ‘unit’ performs at least one function or operation, and may be realized as hardware, software, or combination thereof. In addition, ‘modules’ or ‘units’ may be integrated into at least one module and may be realized as at least one processor (not shown) except for ‘modules’ or ‘units’ that should be realized as a specific hardware.

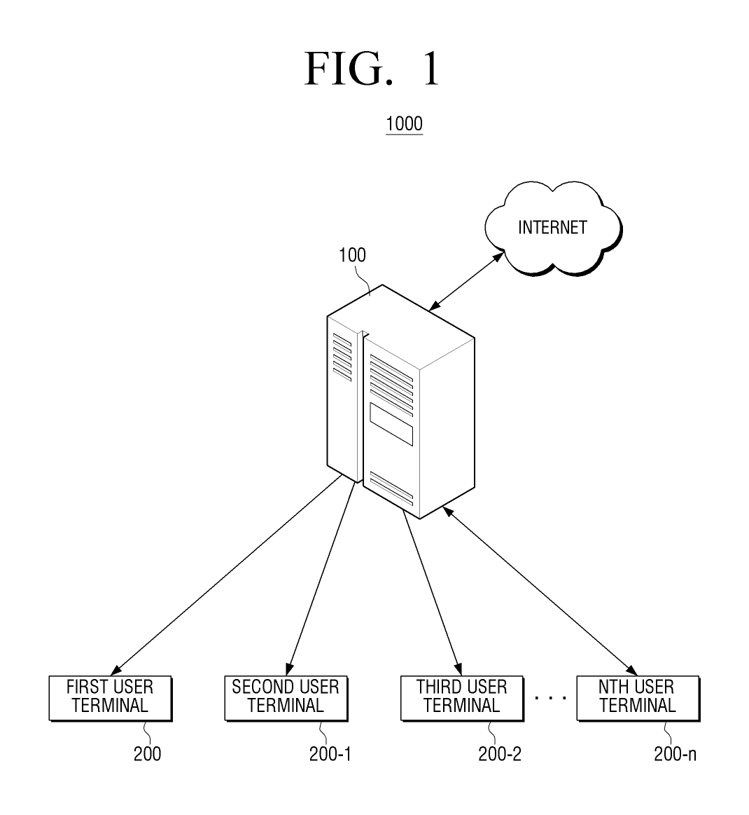

FIG. 1 is a view provided to describe a slide show providing service system according to an embodiment of the present disclosure.

Referring to FIG. 1, the system 1000 includes a server 100 and a plurality of user terminals 200, 200-1, 200-2, . . . 200-n.

The server 100 may update and store contents uploaded from the plurality of user terminals 200, 200-1, 200-2, . . . 200-n in real time. In addition, in response to a command to generate a slide show of sequentially displaying a plurality of slide images being received from a first user terminal 200 that is one of the plurality of user terminals 200, 200-1, 200-2, . . . 200-n, the sever 100 generates a slide show by combing the contents stored in the server 100 or contents in an external server which is accessible through internet and provides the first user terminal 200 with the generated slide show.

In this case, the slide show may refer to an operation of automatically or manually displaying a plurality of contents in a sequential order. Herein, the contents refer to various contents such as a photo, a memorandum, an image, music, etc. Providing a user terminal with a slide show may signify transmitting or streaming a slide show content of sequentially displaying a plurality of slide images to a user terminal. Alternatively, providing a user terminal with a slide show may signify that information on a location where a plurality of contents constituting a slide show are stored and information on an order of displaying the plurality of contents are recorded in a format which is readable by a user terminal (for example, JavaScript™) and provided to the user terminal, the user terminal reads the information, and a slide show is displayed in the user terminal.

The server 100 may be realized so as to generate a slide show or may be realized to provide a user terminal with contents. In this case, an operation of generating a slide show may be performed in the user terminal by using the contents provided from the server 100.

For example, the server 100 may generate a slide show by selecting contents based on information provided from the first user terminal 200 that transmitted the command to generate a slide show. In this case, the server 100 may include contents provided from other user terminals 200-1, 200-2, . . . 200-n in the slide show as well as the contents provided from the first user terminal 200. In addition, the server 100 may communicate with an external server through the internet and include the contents of the external server in the slide show.

As an example, the server 100 may generate a slide show by using a linking open data (LOD) as well as the contents generated and pre-secured in the first user terminal 200. The LOD refers to a platform capable of systematically using public data and has a structure where several related datum are linked to single data, and when a user enters through one of the links, another link datum appears in an interlocked manner. The server 100, which manages the contents provided from the plurality of user terminals 200, 200-1, 200-2, . . . 200-n, provides an LOD platform as described above. In addition, the server 100 may communicate with the external server through the internet and provide an LOD platform in a greater scale. Accordingly, in response to the server 100 generating a slide show, the server 100 may use various datum.

Meanwhile, the server 100 may be a server which provides a social network service (SNS). In addition, the contents stored in the storage of the server 100 may be the contents that the users of the plurality of user terminals 200, 200-1, 200-2, . . . 200-n uploaded to the server through the SNS.

Each of the plurality of user terminals 200, 200-1, 200-2, . . . 200-n is realized as a device which is capable of receiving and displaying a slide show from the server 100. For example, the plurality of user terminals 200, 200-1, 200-2, . . . 200-n may be realized as diverse electronic devices such as a desktop computer, a smart phone, a tablet personal computer (PC), a laptop PC, a portable multimedia player (PMP), a Moving Picture Experts Group phase 1 or phase 2 (MPEG-1 or MPEG-2) audio layer 3 (MP3) player, a television (TV), a wearable device (e.g., smart watch), etc.

Hereinafter, a description on the server 100 which generates a slide show will be provided in further detail according to various embodiments of the present disclosure.

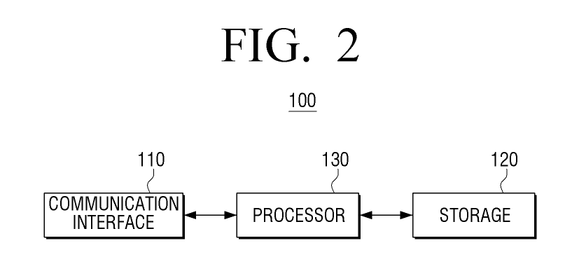

FIG. 2 is a block diagram illustrating a structure of a server according to an embodiment of the present disclosure.

Referring to FIG. 2, the server 100 includes a communication interface 110, a storage 120, and a processor 130.

The communication interface 110 transmits/receives various datum to/from the plurality of user terminals 200, 200-1, 200-2, . . . 200-n or an external server (not shown). The communication interface 110 is formed in order to connect the server 100 to an external device. In addition, the communication interface 110 may be connected to the external device through a local area network (LAN) and an internet network or through a wireless communication method such as Z-wave, Internet Protocol version 4 (IPv4) over low power wireless personal area networks (4LoWPAN), radio frequency identification (RFID), long term evolution (LTE) device to device (D2D), Bluetooth low energy (BLE), general packet radio service (GPRS), weightless, Edge ZigBee, ANT+, near field communication (NFC), infrared data association (IrDA), digital European cordless telephone (DECT), wireless LAN (WLAN), Bluetooth, Wi-Fi, Wi-Fi Direct, general system/standard for mobile communication (GSM), universal mobile telephone system (UMTS), LTE, wireless broadband Internet (WiBro), etc.

For example, the communication interface 110 may receive a content, a command to generate a slide show, and the like from the plurality of user terminals 200, 200-1, 200-2, . . . 200-n and may transmit various forms of slide shows according to control of the processor 130. For example, the communication interface 110 may transmit a uniform/universal resource locator (URL) address to be connected to script information for reproducing a slide show to a user terminal or may transmit a slide show content where a plurality of contents constituting a slide show are encoded to the user terminal thereby providing the user terminal with the slide show.

The storage 120 stores various programs and datum for driving the server 100. The storage 120 may be realized as a non-volatile memory, a volatile memory, a flash memory, a hard disk drive (HDD), a solid state drive (SSD), etc. The storage 120 may be accessed by the processor 130, and the data in the storage 120 may be read/recorded/edited/deleted/updated by the processor 130. In the present embodiment, the term ‘storage’ may include a memory card (not shown/e.g., a micro secure digital (SD) card, a memory stick, etc.) which is installed in the storage 120, a read-only memory (ROM) in the processor 130, random access memory (RAM/not shown), or the server 100.

The storage 120 may store the contents received from a plurality of user terminals. In addition, the storage 120 may store information on the contents. The processor 130 may select the contents to be included in a slide show by using the information on the contents. For example, the information on the contents may include a user terminal which generated the contents, a time when the contents were generated, a geographical location of the user terminal at the time when the contents were generated in the user terminal.

The storage 120 may classify and store the contents by category. For example, the storage 120 may classify and store background music contents to be included in a slide show by theme.

In addition, the storage 120 may store various templates of a slide show. The processor 130 may generate a slide show in various designs by using the templates in the storage 120.

The processor 130 controls the components of the server 100. For example, the processor 130 may control overall operations of the server 100 by using diverse programs stored in the storage 120. The processor 130 may include a central processing unit (CPU), a RAM, a ROM, and a system bus. In this case, the ROM stores a set of commands for system booting. The CPU copies an operating system (O/S) stored in the storage 120 into the RAM according to a command stored in the ROM, and boots up a system by executing the O/S. Upon completion of the boot-up operation, the CPU copies various applications stored in the storage 120 into the RAM and executes the applications copied into the RAM 131 to perform various operations. In the above description, the processor 130 includes one CPU, but the processor 130 may be realized to include a plurality of CPUs (or digital signal processing (DSP), system on chip (SoC), etc.)

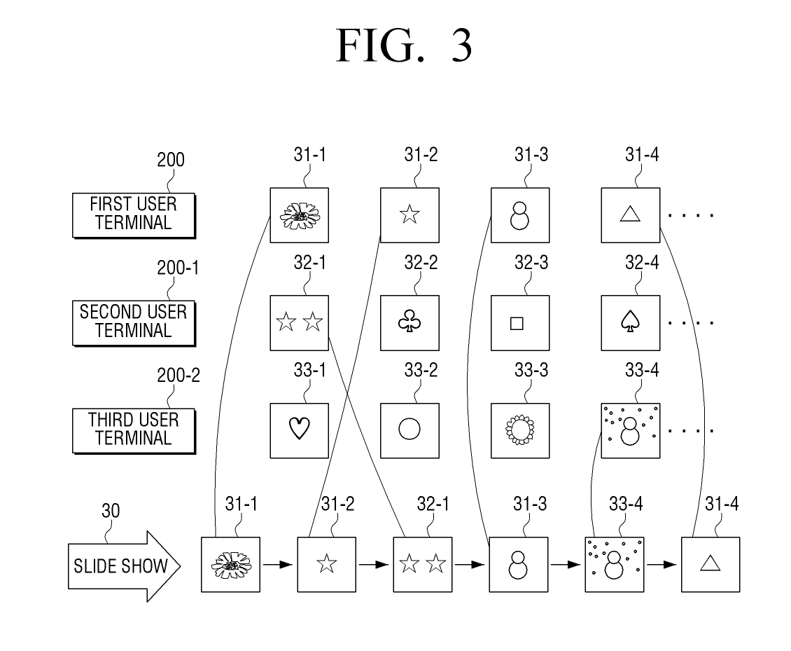

In response to a command to generate a slide show of sequentially displaying a plurality of slide images being received from the first user terminal 200 that is one of the plurality of user terminals 200, 200-1, 200-2, . . . 200-n, the processor 130 may select contents according to various standards and generate a slide show. Hereinafter, a method for generating a slide show of the server 100 according to various embodiments will be described with reference to FIGS. 3 to 7.

FIGS. 3, 4, 5, 6, and 7 are views provided to describe a method for generating a slide show according to various embodiments of the present disclosure.

According to an embodiment of the present disclosure, the processor 130 may generate a slide show by combining the contents of the first user terminal 200 that transmitted the command to generate a slide show (target content) and contents related to the target content (related content) from among the contents stored in the storage 120. This embodiment will be described below in further detail with reference to FIG. 3.

FIG. 3 is a view provided to describe a method for generating a slide show according to an embodiment of the present disclosure.

Referring to FIG. 3, the storage 120 stores contents 31-1, 31-2, 31-3 and 31-4 transmitted from the first user terminal 200, contents 32-1, 32-2, 32-3, and 32-4 transmitted from the second user terminal 200-1, and contents 33-1, 33-2, 33-3, and 33-4 transmitted from the third user terminal 200-2. The processor 130 may generate a slide show 30 by using the contents stored in the storage 120. For example, the processor 130 may generate the slide show 30 by combining the contents transmitted from the first user terminal 200 that transmitted the command to generate a slide show and the contents 32-1, 33-4 related to the contents of the first user terminal 200.

In this case, the content which is ‘related’ to the target content refers to a content which may correspond to certain information that may be extracted from the target content. For example, in response to text of the target content including a particular keyword, the keyword and a synonym of the keyword are used to retrieve the related content. As another example, in response to the target content including an image, the processor 140 may perform an analysis of the image, and in response to determining that the image includes a face of a particular figure, the processor 130 may select a content including information related to the figure as the related content. In addition, in response to the target content including an image, the processor 140 may perform an analysis of the image, and in response to determining that the image is a photo including a particular background (e.g., a sea), the processor 130 may select a content related to the sea as the related content. Meanwhile, based on information of a time when the target content was generated or uploaded or a location where the target content was generated or uploaded, the processor 130 may select a content generated in the location and/or at the time as the related content.

That is, according to various embodiments of the present disclosure, a user is able to be provided with a slide show including the target contents generated in his/her own user terminal and the related contents which were uploaded to the server 100 by other users in connection with the target content. In addition, the user is able to be provided with abundant slide shows consisting of the related contents based on a result obtained by comprehensively analyzing various information included in his/her contents.

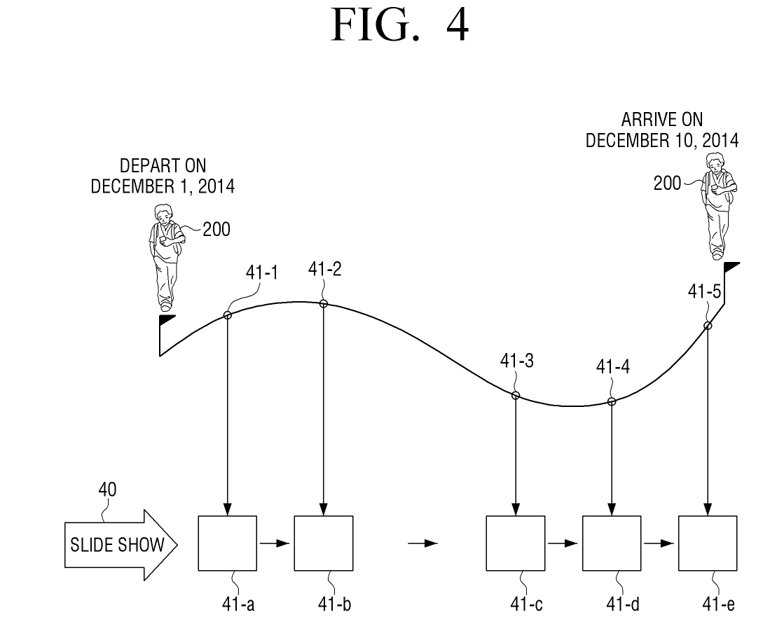

According to an embodiment of the present disclosure, a slide show may be provided even though a target content does not exist. For example, according to the present embodiment of the present disclosure, the processor 130 may generate a slide show by using contents related to a moving route of the first user terminal 200. The embodiment of the present disclosure will be described below in further detail with reference to FIG. 4.

FIG. 4 is a view provided to describe a method for generating a slide show according to an embodiment of the present disclosure.

Referring to FIG. 4, in response to period-designation information and moving route information being received from the first user terminal 200, the processor 130 may generate a slide show by using contents related to a route where the first user terminal 200 moved for a period corresponding to the period-designation information (Dec. 1, 2014 to Dec. 10, 2014).

In this case, the first user terminal 200 may be realized as a device having a function of recording a moving location of the first user terminal 200 (e.g., a global positioning system (GPS) function) and may transmit information on the route where the first user terminal 200 moved for a designated period to the server 100. The processor 130 determines a location where the first user terminal 200 does not move out of a predetermined distance range for a predetermined time within a period corresponding to the period-designation information based on the received information as a location where the user stayed. Subsequently, the processor 130 generates a slide show by using the contents related to the location where the user stayed. For example, the processor 130 may determine that the user stayed in five locations 41-1, 41-2, 41-3, 41-4, and 41-5 by analyzing the moving route of the first user terminal 200 during the user-designated period from December 1, 2014 to December 10, 2014 and provides a slide show by using the contents related to each location.

For example, the processor 130 may retrieve a landmark which is located close to the locations 41-1 to 41-5 through the internet based on the information (latitude and longitude) on the locations 41-1 to 41-4. For example, the processor 130 may obtain information on a landmark, such as, a mountain, a park, a historic site, etc., corresponding to the information on the location by using open application programming interface (API) such as GeoNames. In addition, in response to information on a plurality of landmarks being obtained, the processor 130 may select a main landmark based on a distance, popularity (search frequency), etc.

Meanwhile, the processor 130 may generate a slide show 40 by using contents 41-a, 41-b, 41-c, 41-d, 41-e including information on a landmark of each location from among the contents stored in the storage 120. In this case, the slide show does not need to be generated by only the contents stored in the storage 120. That is, the contents related to a moving route stored in an external server (not shown) may be added to the slide show 40. For example, the processor 130 may generate the slide show 40 by obtaining data through Dbpedia and Wikipedia.

As described above, the embodiment of generating a slide show by using a content transmitted from a user terminal and related content was described with reference to FIG. 3, and the embodiment of generating a slide show by using the contents related to a moving route of a user terminal was described with reference to FIG. 4. A slide show may be provided according to an embodiment where the above embodiments are combined. That is, the server 100 may provide a slide show including all of the target contents that a user terminal transmitted or uploaded to the server 100 while moving, related contents which are related to the transmitted or uploaded contents, and the content related to the moving route.

The embodiment may be applied to a following situation. For example, when a user uploads his/her travel record to the server 100 through a user terminal during a travel, the travel record may be a photo or may be a memorandum on the user's feeling. The server 100 may generate a travel slide show by using the uploaded photo contents, memo contents, and the like or may generate a slide show by additionally including the related contents which are related to the uploaded contents and contents related to a travel route.

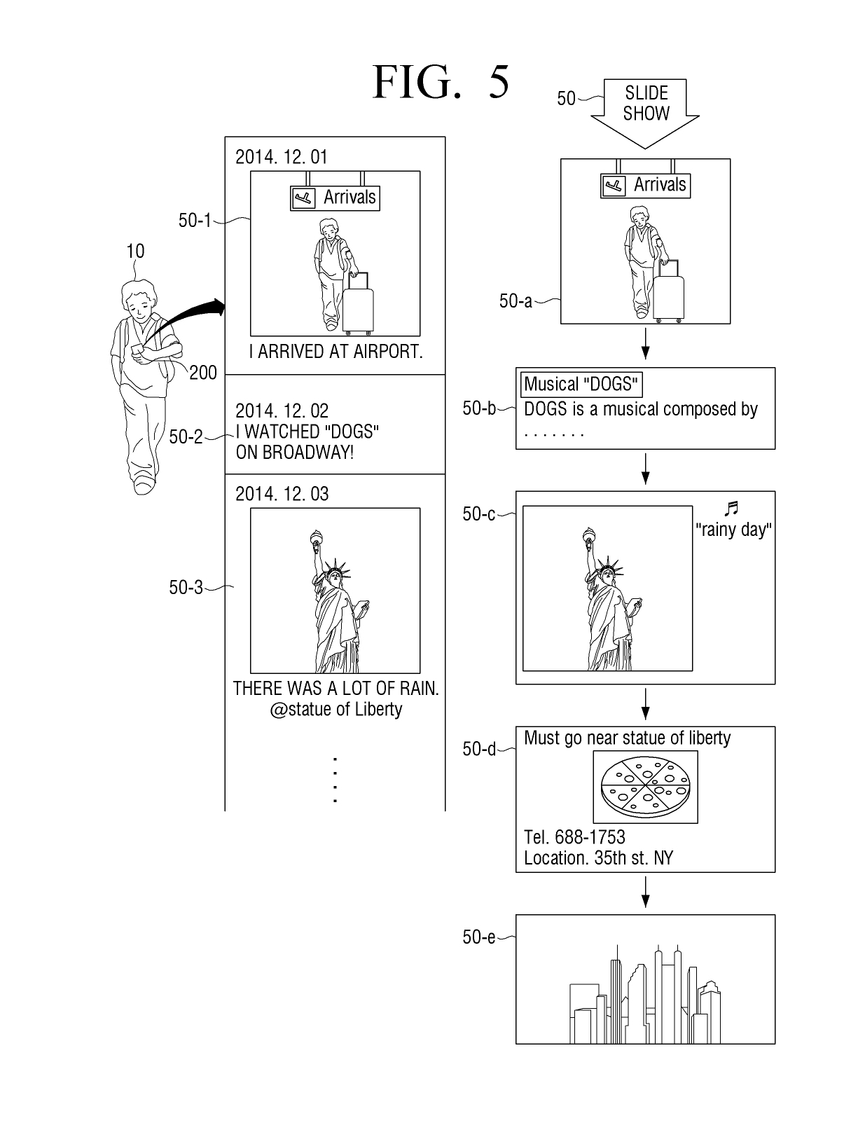

The embodiment will be described with reference to FIG. 5.

FIG. 5 is a view provided to describe a method for generating a slide show according to an embodiment of the present disclosure.

Referring to FIG. 5, a user 10 transmits or uploads contents 50-1, 50-2, 50-3 to the server 100 while moving with the user terminal 200. Subsequently, in response to receiving information on a designated period and information on a moving route where the user terminal 200 moved for the designated period, the processor 130 generates a slide show 50 by using the target contents 50-1, 50-2, 50-3 being generated or uploaded while the user terminal 200 moves for the designated period, related contents which are related to the target contents, and contents related to the moving route.

For example, in response to a period being designated by the user terminal 200, the processor 130 may select the contents generated or uploaded for the period from among the contents transmitted from the user terminal 200 as the target contents 50-1, 50-2, 50-3. In addition, the processor 130 may generate the slide show 50 by additionally including the target contents 50-1, 50-2, 50-3, the related contents which are related to the target contents 50-1, 50-2, 50-3, and/or the contents related to the moving route. In this case, the contents related to the moving route may be the contents generated or uploaded in a location where the user terminal 200 stayed over a predetermined time within the period designated by the user terminal or the contents related to the location.

More particularly, referring to FIG. 5, a slide 50-a includes a photo content 50-1 uploaded by a user. A slide 50-b includes a text contents 50-2 and information on a musical that the user watched. In this case, the processor 130 may analyze keywords (Broadway and DOGS) included in the text contents 50-2 comprehensively and determine an intention (musical DOGS) of the text content 50-2. In addition, in this case, the processor 130 may enhance accuracy of analysis of the intention of the content with reference to a location where the text content 50-2 was uploaded (Broadway, U.S.A.). A slide 50-c includes photos included in a content 50-3. The processor 130 may extract a word ‘rain’ from text ‘there was a lot of rain’ included in the content 50-3 and add background music (rainy day) corresponding to the extracted word as background music of the slide 50-c. The processor 130 may generate a slide 50-d by using information on a restaurant in a location where the content 50-3 was generated or uploaded based on location information on the location (Statue of Liberty). In addition, in response to determining that the user terminal 200 stayed in a certain location over a predetermined time based on the information on the moving route received from the user terminal 200, the processor 130 may generate a slide show 50 by adding a slide 50-e including information on the location or a landmark in the vicinity of the location.

As described above, the server 100 may analyze the contents and information provided by the user terminal 200 comprehensively, select the related contents, and generate a slide show by using the contents.

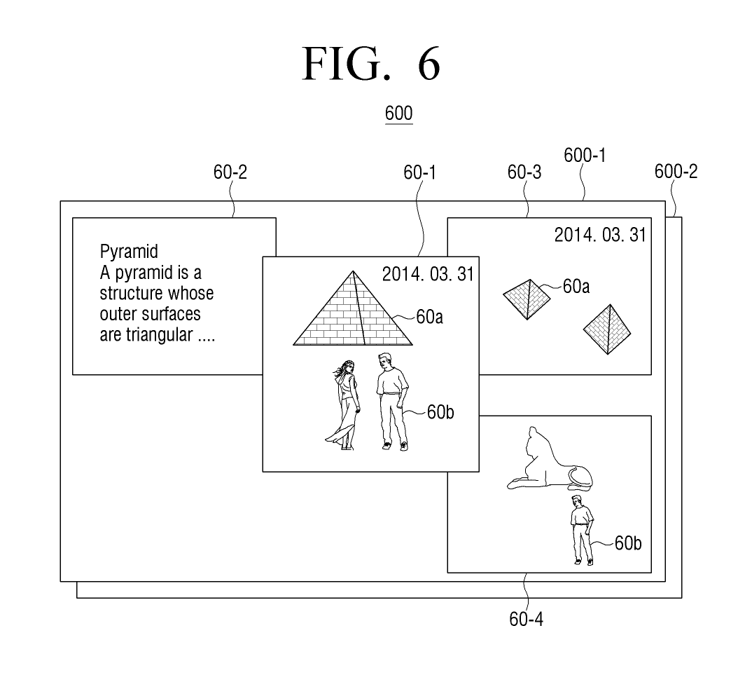

FIG. 6 is a view provided to describe a method for generating a slide show according to an embodiment of the present disclosure.

Referring to FIG. 6, a slide show 600 may include a plurality of slides 600-1, 600-2. The slide 600-1 may include a target content 60-1 and a plurality of related contents 60-2, 60-3, 60-4.

The processor 130 may analyze an image included in the target content 60-1 and generate a slide 600-1 by selecting one or more related contents 60-2, 60-3, 60-4 according to an analyzed result. For example, the processor 130 performs an image analysis for identifying an object in an image included in the target content 60-1. The image analysis for identifying an object is performed according to a method in the related art. The processor 130 may identify an object, such as, a figure, a background, a thing, etc., included in the image through the image analysis, select a content related to the identified object as a related content, and include the related content in the slide.

For example, the processor 130 may determine that a thing in the target content 60-1 is pyramid through the image analysis and add the content 60-2 including information on the pyramid to the slide 600-1.

Meanwhile, the processor 130 may determine the content 60-2 by analyzing location information on the target content 60-1 instead of analyzing an image. For example, the processor 130 may identify a pyramid 60a that is a landmark located in the vicinity of the location where the target content 60-1 was generated or uploaded based on information on the location (latitude and longitude). In this case, in response to several landmarks (pyramid, sphinx) being searched in the vicinity of the location, the processor 130 may select a landmark which is closest to the location or have the highest search frequency from among the landmarks and generate the content 60-1 by using information on the selected landmark.

The processor 130 may perform the image analysis and select a related content to be included in the slide 600-1 based on information on a FIG. 60b included in the target content 60-1. For example, the processor 130 may extract a face area from a photo of the target content 60-1, compare the extracted face area with face information pre-stored in the user terminal 200 or the server 100, and identify who is the FIG. 60-1. For example, in response to a telephone directory including contact information and a profile photo being stored in the user terminal 200, the processor 130 may compare the face area extracted from the photo with the profile photo in the telephone directory and identify the FIG. 60b. As another example, the storage 120 of the server 100 may store profile photos and user information of users who use the server 100 (e.g., cloud, SNS address list, etc.), and the processor 130 may identify the FIG. 60-b by using the information.

In response to the FIG. 60-b being identified, the processor 130 may add the related content 60-4 including the identified FIG. 60-b from among the contents stored in the storage 120 to the slide 600-1. In this case, in order to enhance the degree of association between the target content 60-1 and the related content 60-4, the processor 130 may use figure information of the target content 60-1 and other contents to select the content 60-4. For example, the processor 130 may select the content 60-4 corresponding to the figure information of the target content 60-1 and the information on the location where the target content 60-1 was generated or uploaded and/or the time when the target content 60-1 was generated or uploaded as the related content. Accordingly, the content 60-4 which includes the FIG. 60-b and was generated in the sphinx close to the pyramid that is the location where the target content 60-1 was generated may be selected as the related content.

In addition, the processor 130 may select photos classified by time in the location regarding the target content 60-1 as the related content based on location information on location of the target content 60-1. For example, the processor 130 may select the content 60-3 on the same date as the date when the target content 60-1 was generated from among the content related to the location as the related content based on the information on the location where the target content 60-1 was uploaded or transmitted. Accordingly, the user is able to be provided with the photos taken by other users in the location (pyramid) that the user visited through the slide show, and thus, the user is able to see the pyramid in several angles at the same date. In addition, the processor 130 may select a photo taken in the past or in the future of the date when the target content 60-1 was generated as the related content, as well as the photo taken on the date when the target content 60-1 was generated. Accordingly, the user is able to provide with the photos classified by time in the location through the slide show. That is, the processor 130 may determine a content generated in the location where the target content 60-1 was generated and at a time within a predetermined range with respect to the time when the target content 60-1 was generated as the related content based on the information on the location and time.

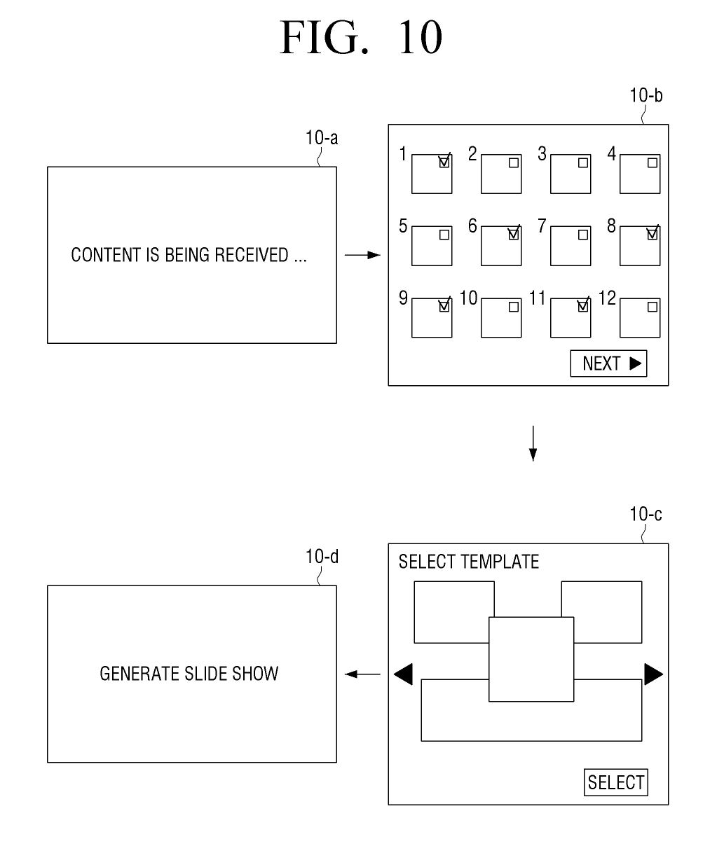

Meanwhile, a template of a slide show illustrated in FIG. 6 is only an example, and the server 100 stores templates in various designs. The server 100 may select a template automatically by considering the number of the target contents and the related contents. Alternatively, a template may be selected by the user terminal 200. This embodiment will be described below in further detail with reference to FIG. 10.

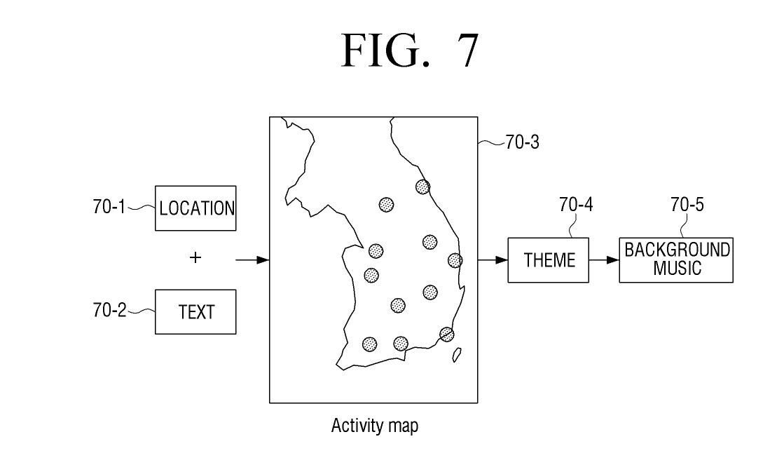

Meanwhile, the server 100 may generate a slide show by adding the background music on top of the contents such as photos. Hereinafter, an embodiment of adding background music to a slide show will be described with reference to FIG. 7.

FIG. 7 is a view provided to describe a method for selecting background music according to an embodiment of the present disclosure.

The processor 130 may select background music based on various information included in the contents constituting a slide show. For example, the storage 120 stores diverse music to be used as the background music by theme, and the processor 130 may select the background music according to a theme of the contents constituting a slide show. As an example, a theme of a content may be determined based on a keyword extracted from text included in the content and location information on a location where the content was generated or uploaded.

Referring to FIG. 7, the processor 130 may determine a theme 70-4 of a content based on location information 70-1 included in the content and a keyword extracted from text 70-2. For example, activity map 70-3 is data where activities performed in particular areas (e.g., mountain climbing, golf, swimming, cycling, shopping, etc.) are databased, and the processor 130 may obtain information on an activity which may be enjoyed in a location corresponding to the location information 70-1 from the activity map 70-3. In response to an activity which may be enjoyed in a location corresponding to the location information 70-1 being swimming and hiking, the processor 130 may analyze the text 70-2 and determine what is the activity in which a user participated. For example, in response to the text 70-2 included in the content being ‘cool swimming,’ the processor 130 may determine that the user enjoyed swimming at sea based on the keyword ‘swimming ’ Subsequently, the processor 130 may select background music 70-5 classified as a theme corresponding to swimming

That is, according to the embodiment, in reproducing a slide show, tedium according to the background music being fixed regardless of a content may be resolved, and background music suitable for the content may be provided by comprehensively analyzing various information included in the content.

A slide show generated in the server 100 according to above described various methods may be provided to a user in diverse methods. The methods will be described below.

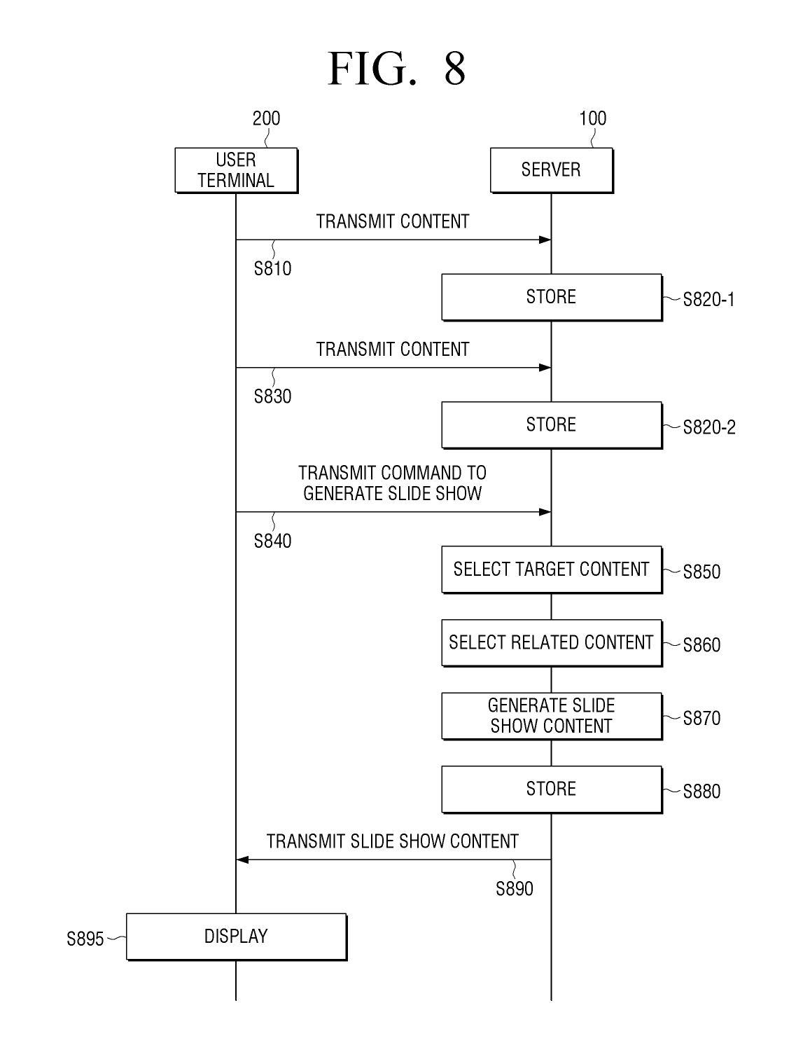

FIG. 8 is a sequence diagram provided to describe a method for generating a slide show of a server according to an embodiment of the present disclosure.

Referring to FIG. 8, the user terminal 200 may transmit or upload contents to the server 100 according to a user command at operation S810. The server 100 stores the transmitted/uploaded contents at operation S820-1. Subsequently, the user terminal 200 may transmit or upload contents to the server 100 according to a user command at operation S830. The server 100 stores the transmitted/uploaded contents at operation S820-2. That is, the server 100 may update the storage 120 of the server 100 in real time by storing the contents received from the user terminal 200 in real time, and thus, may maintain the contents stored in the storage up-to-date. A slide show is generated based on the contents stored in the storage 120, and thus, the side show may be also formed with the up-to-date contents.

In response to a command to generate a slide show being transmitted from the user terminal 200 at operation S840, the server 100 selects the contents transmitted from the user terminal 200 as target contents at operation S850 and selects related contents at operation S860. The related contents may be the contents stored in the storage 120 or may be contents obtained from an external server (not shown) through the internet. That is, the server 100 may use the contents which are pre-stored in the storage 120 as the related contents and may also use the contents stored in the external server as the related contents by retrieving the contents in real time.

Meanwhile, in response to the contents transmitted from the user terminal 200 not existing, that is, a content to be used as a target content not existing, the server 100 may generate a slide show based on the information on the moving route of the user terminal 200. The embodiment has been described above, and thus, the overlapped description is omitted.

The server 100 generates a slide show content by combining the target contents and the related contents at operation S870. The server 100 stores the generated slide show content at operation S880 and transmit the slide show content to the user terminal 200 at operation S890. The user terminal 200 displays the received slide show content at operation S895.

In the above described embodiment, a slide show is provided in the manner that the server 100 generates the slide show content and transmits the slide show content to the user terminal 200. However, according to another embodiment of the present disclosure, a slide show is generated on the Web in a language such as hypertext mark-up language (HTML), cascading style sheets (CSS), JavaScript, etc., and the server 100 provides the user terminal 200 with a web address (e.g., URL address). The user terminal 200 may display the slide show by accessing the provided web address through the Internet.

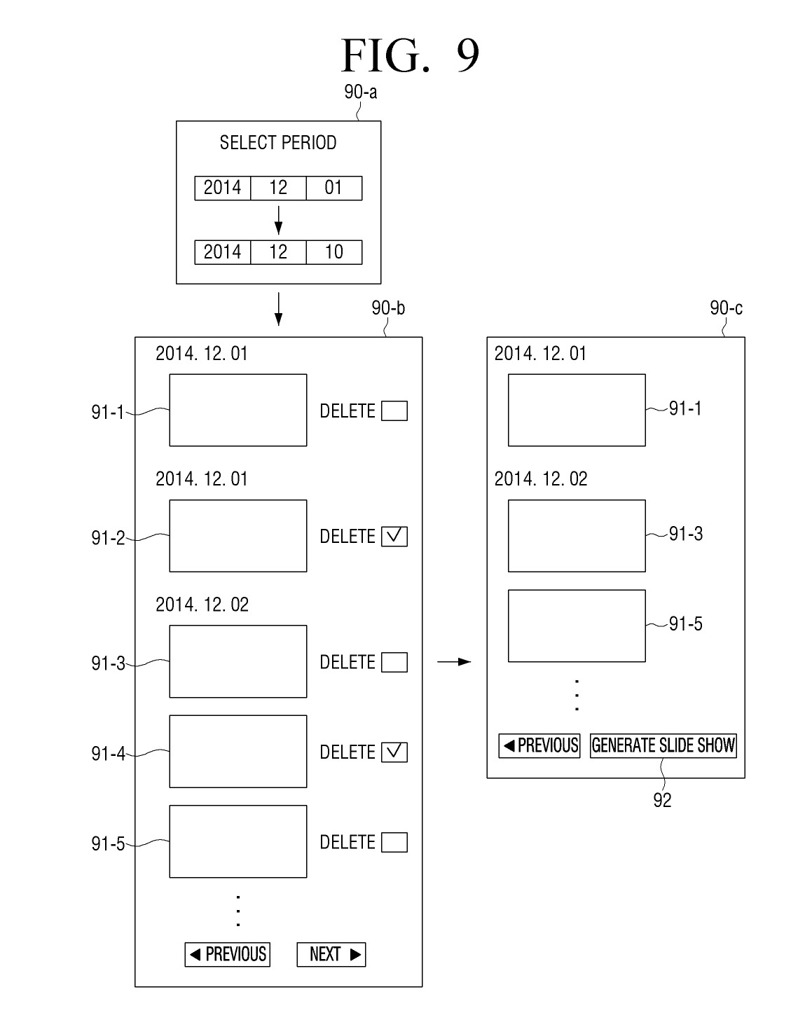

Meanwhile, as described above, the server 100 may determine target content automatically and generate a slide show. According to another embodiment of the present disclosure, target content to be included in a slide show may be selected through the user terminal 200. The embodiment will be described below with reference to FIG. 9.

FIG. 9 is a view illustrating a user interface (UI) screen which may be provided in a user terminal to generate a slide show according to various embodiments of the present disclosure.

Referring to FIG. 9, the user terminal 200 may include a display to display screens 90-a, 90-b, 90-c illustrated in FIG. 9. A user is able to input a command to select target contents to generate a slide show through an input unit (not shown) based on the displayed screens.

For example, the user terminal 200 provides the screen 90-a for receiving a selection of a period, and in response to the period being selected, the screen 90-b including a content list of the contents 91-1, 91-2, 91-3, 91-4, and 91-5 generated in the period is provided. The contents in the content list are the contents pre-stored in the user terminal 200. In this case, the user is able to delete the contents 91-2, 91-4 not to be included in the slide show. In response to the contents 91-2, 91-4 being deleted, the user terminal 200 displays the screen 90-c including a list consisting of selected target contents. In response to a button 92 for generating a slide show being selected, the user terminal 200 transmits information on the target contents to the server 100.

The sever 100 determines the target contents from among the contents stored in the storage 120 based on the information on the received target contents, determines related contents which are related to the target contents, and generate a slide show.

In the above described embodiment, the server 100 performs an operation of generating a slide show. However, according to an embodiment of the present disclosure, the user terminal 200 may perform the operation of generating a slide show. Hereinafter, this embodiment will be described with reference to FIG. 10.

FIG. 10 is a view provided to describe an operation of generating a slide show by a user terminal according to an embodiment of the present disclosure.

Referring to FIG. 10, the user terminal 200 may include a display to display screens 10-a, 10-b, 10-c, 10-d. The user is able to input a manipulation command to generate a slide show based on the displayed screens.

In response to target contents being selected, the user terminal 200 transmits information on the selected target contents to the server 100. In this case, the embodiment described above with reference to FIG. 9 may be applied to the method of determining the target contents.

The server 100 transmits related contents which are related to the target contents to the user terminal 200 or transmits information on a storage location where the related contents are stored to the user terminal 200. In this case, the screen 10-a which displays a content receiving state may be provided.

The user terminal 200 may display the related contents transmitted from the server 100 and the selected target contents in the screen 10-b. The user is able to select the contents to be included in a slide finally. An order of displaying the contents may be set by default so as to be based on an order of generating the contents, but the user is able to designate the order of displaying the contents again through the screen 10-c.

In response to the contents being selected, the user terminal 200 may display the screen 10-c for receiving a selection of a template design of a slide show, and the user is able to select a template for determining a design of the slide show. In response to the template being selected, the slide show is generated and displayed (10-c).

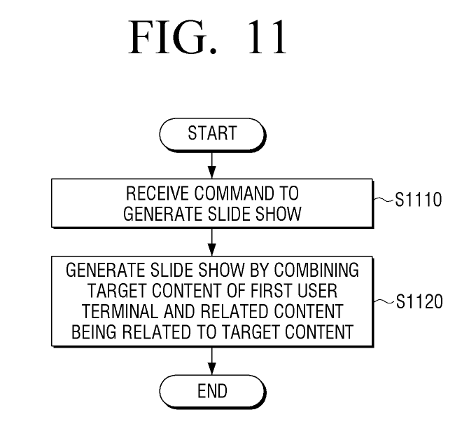

FIG. 11 is a flowchart provided to describe a method for generating a slide show according to an embodiment of the present disclosure.

Referring to FIG. 11, the server 100 receives a command to generate a slide show of sequentially displaying a plurality of slide images from the user terminal 200 at operation S1110. Subsequently, the server 100 generates a slide show by combining the target contents of the user terminal 200 from among the contents stored in the storage 120 and the related contents which are related to the target contents at operation S1120. In this case, the contents stored in the storage 120 are the contents transmitted from the plurality of user terminals.

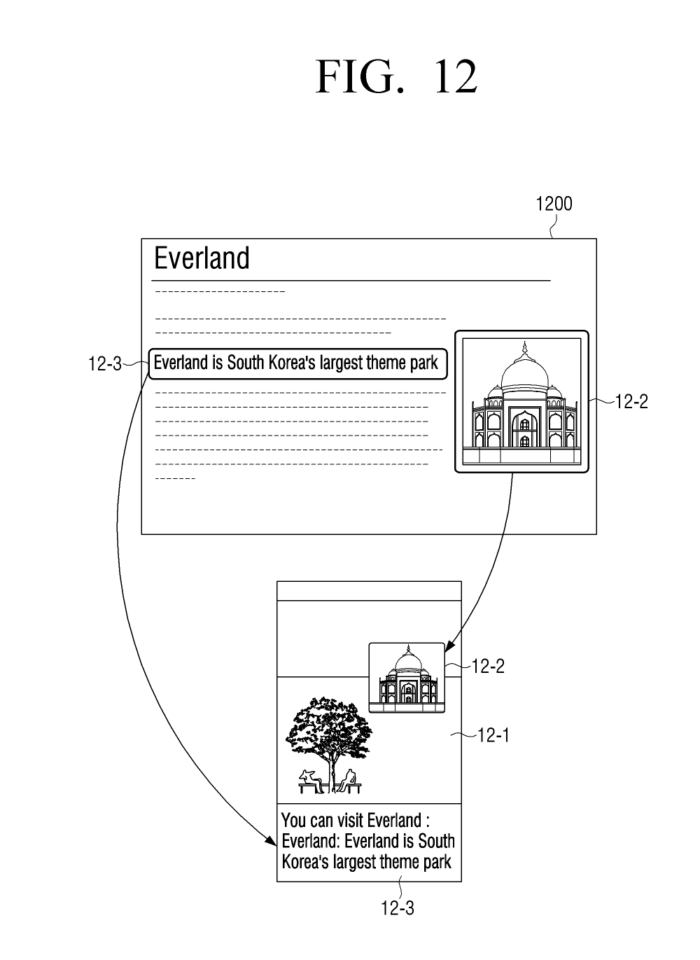

According to an embodiment of the present disclosure, as well as the contents transmitted from the plurality of user terminals and pre-stored in the storage 120, the contents stored in an external server may be used to generate a slide show. As an example, the processor 130 may perform an internet search in order to determine the related contents. The embodiment will be described below in further detail with reference to FIG. 12.

FIG. 12 is a view provided to describe a slide show which is generated according to an embodiment of the present disclosure.

Referring to FIG. 12, the processor 130 may generate a slide show by combining a target content 12-1 and related contents 12-2, 12-3 which are related to the target content 12-2, and the related contents 12-2, 12-3 may be extracted from a web page 1200. For example, the processor 130 may perform an internet search to a location corresponding to location information on a location where the target content 12-1 was generated or uploaded and extract an image content 12-2 and a text content 12-3 from the searched web page 1200. In addition, the processor 130 may generate a slide show by arranging the extracted related contents 12-2, 12-3 in a slide along with the target content 12-1.

According to the above embodiments, a slide show may be generated by using various external contents as well as the contents stored in the storage 120.

In the above described embodiment, the server 100 performs the operation of generating a slide show. However, according to an embodiment of the present disclosure, the user terminal 200 may perform the operation of generating a slide show. Hereinafter, this embodiment will be described below in further detail.

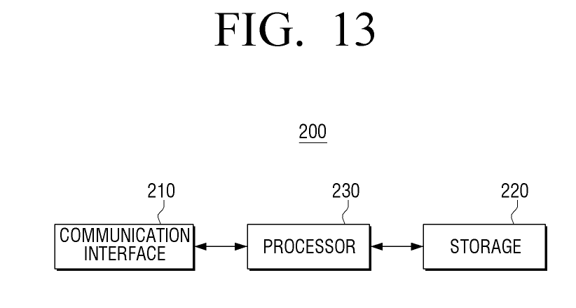

FIG. 13 is a block diagram illustrating a structure of a user terminal according to an embodiment of the present disclosure.

Referring to FIG. 13, the user terminal 200 includes a communication interface 210, a storage 220, and a processor 230. For example, the user terminal 200 is realized as a device capable of generating and reproducing a slide show. For example, the user terminal 200 may be realized as diverse electronic devices such as a desktop PC, a smart phone, a tablet PC, a laptop PC, a PMP, an MP3 player, a TV, a wearable device (e.g., smart watch), etc.

The communication interface 210 is formed to connect the user terminal 200 to an external device. The communication interface 210 may be connected to the external device through a LAN and an internet network or may be connected to the external device according to a wireless communication methods such as Z-wave, 4LoWPAN, RFID, LTE D2D, BLE, GPRS, Weightless, Edge Zigbee, ANT+, NFC, IrDA, DECT, WLAN, Bluetooth, Wi-Fi, Wi-Fi Direct, GSM, UMTS, LTE, WiBRO, etc.

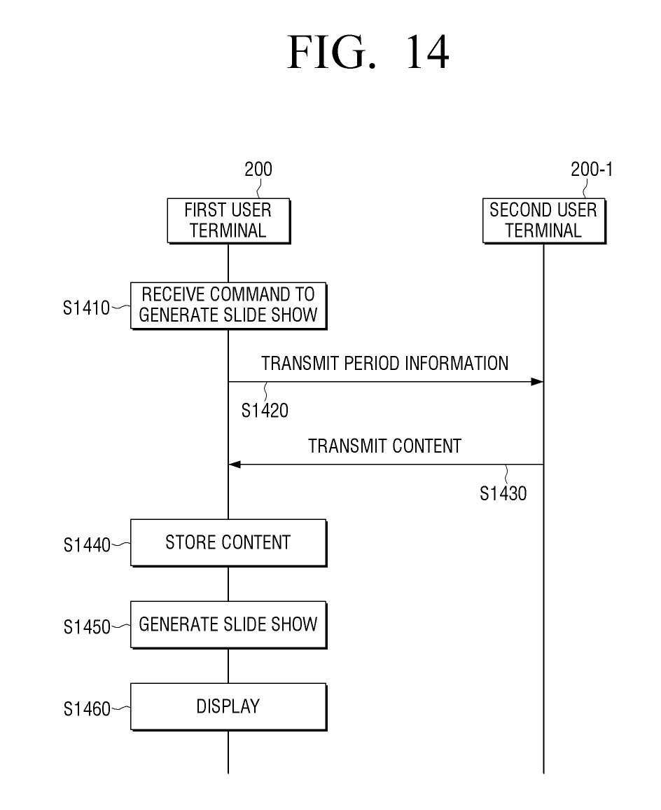

For example, the communication interface 210 may receive contents necessary for generating a slide show from the server 100. In addition, the communication interface 210 may receive contents necessary for generating a slide show from another user terminal. The embodiment of receiving contents from another user terminal and generating a slide show will be described below in further detail with reference to FIG. 14.

The storage 220 stores various programs and datum for driving the server 100. The storage 220 may be realized as a non-volatile memory, a volatile memory, a flash memory, an HDD, an SSD) etc. The storage 220 may be accessed by the processor 230, and the data in the storage 220 may be read/recorded/edited/deleted/updated by the processor 230. In the present embodiment, the term ‘storage’ may include a memory card (not shown/e.g., a micro SD card, a memory stick, etc.) which is installed in the storage 120, a ROM in the processor 130, RAM/not shown, or the server 100.

The storage 220 may store the contents generated in the user terminal 200 and the contents received from the external device. For example, the user terminal 200 may generate contents by using means such as a photographing unit, a microphone, etc., and the generated contents are stored in the storage 220. In addition, the storage 220 may store information on the contents. The processor 230 may select the contents to be included in a slide show by using the information on the contents. For example, the information on the contents may include a user terminal which generated the contents, a time when the contents were generated, a geographical location of the user terminal at the time when the contents were generated in the user terminal, etc.

The storage 220 may classify and store the contents by category. For example, the storage 220 may classify and store background music contents to be included in a slide show by theme.

In addition, the storage 220 may store various templates of a slide show. The processor 230 may generate a slide show in various designs by using the templates in the storage 220.

The processor 230 controls the components of the user terminal 200. For example, the processor 230 controls overall operations of the server 100 by using diverse programs stored in the storage 220. For example, the processor 230 may include a CPU, a RAM, a ROM, and a system bus. In this case, the ROM stores a set of commands for system booting. The CPU copies an 0/S stored in the storage 220 into the RAM according to a command stored in the ROM, and boots up a system by executing the 0/S. Upon completion of the boot-up operation, the CPU copies various applications stored in the storage 220 into the RAM and executes the applications copied into the RAM to perform various operations. In the above description, the processor 230 includes one CPU, but the processor 230 may be realized to include a plurality of CPUs (or DSP, SoC, etc.)

In response to a command to generate a slide show being received through an input unit (not shown), the processor 230 may receive the related contents which are related to the pre-stored target contents from the external device and generate a slide show by combining the target contents and the related contents.

For example, the processor 230 may control the external device so as to transmit the related contents which are related to the target contents. For example, the processor 230 may transmit information on the target contents to the server 100 that is the external device and request to the server 100 to provide contents corresponding to the information on the target contents. In response to the request being received, the server 100 may retrieve the related contents which are related to the target contents from the storage 120 and provide the user terminal 200 with the related contents. The method of determining the related contents by the server 100 has been described above, and thus, the overlapped description is omitted.

The user terminal 200 may receive the related contents which are related to the target contents from a server other than the server 100 and add the received related contents to a slide show. For example, the processor 230 may perform the internet search and receive the contents to be included in the slide show through the communication interface 210.

Meanwhile, according to an embodiment of the present disclosure, the user terminal 200 may receive the contents to be included in the slide show by communicating with another user terminal in a peer-to-peer (P2P) method. That is, the user terminal 200 may receive the contents from another terminal designated by a user and generate a slide show. This embodiment will be described below with reference to FIG. 14.

FIG. 14 is a sequence diagram provided to describe a method for generating a slide show of a user terminal according to an embodiment of the present disclosure. Hereinafter, it is assumed that a user terminal is the first user terminal 200.

Referring to FIG. 14, in response to a command to generate a slide show being received through an input unit (not shown) of the first user terminal 200 at operation S1410, the first user terminal 200 performs a communication connection with a predetermined second user terminal (200-1).

For example, the communication connection may be performed in the following manner. In response to the first user terminal 200 designating the second user terminal 200-1 to which the communication is connected, a communication connection request is transmitted from the first user terminal 200 to the second user terminal 200-1, and in response to the second user terminal 200-1 accepting the request, the communication may be connected. Such communication connection may be performed in various methods including NFC tagging, Bluetooth, etc.

The first user terminal 200 requests to provide particular contents to the second user terminal 200-1 where the communication connection is performed. As an example, the first user terminal 200 may transmit period information at operation S1420. In response to receiving the period information, the second user terminal 200-1 transmits the contents generated in the second user terminal 200-1 within a period corresponding to the received period information to the first user terminal 200 at operation S1430. The first user terminal 200 stores the received contents at operation S1440 and generates a slide show by combining the received contents and the contents generated in the first user terminal 200 within the period corresponding to the period information at operation S1450. The first user terminal 200 displays the generated slide show at operation S1460.

According to the above embodiments, it is possible to generate a slide show by combining photos taken by respective user terminals during a trip, for example.

By the method for generating a slide show according to various embodiments, a user is able to be provided with a slide show generated by using various contents on top of his/her own contents. In addition, various information on his/her own contents may be analyzed comprehensively, and the contents related to the information may be provided through the slide show. Accordingly, the user is able to enjoy more abundant experiences through the slide show.

The method for generating a slide show according to the above various embodiments may be realized as a program including an algorithm which is executable in a computer, and the program may be provided through a non-transitory computer readable medium. The non-transitory computer readable medium may be mounted in diverse devices.

The non-transitory computer readable medium refers to a medium which may store data permanently or semi-permanently rather than storing data for a short time such as a register, a cache, and a memory and may be readable by an apparatus. As an example, the above-described various applications and programs may be stored in the non-transitory computer readable medium such as a compact disc (CD), a digital versatile disc (DVD), a hard disk, a Blu-ray disk, a universal serial bus (USB), a memory card, a ROM, and the like, and provided therein.

Accordingly, the program may be installed in an existing device, and a device, such as a server or a user terminal, capable of generating a slide show by comprehensively using various contents may be realized.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A server comprising:
a communication interface configured to perform communication with a plurality of user terminals;
a storage configured to receive and store contents through the communication interface, the contents being transmitted from the plurality of user terminals; and
a processor configured to, in response to a command to generate a slide show for sequentially displaying a plurality of slide images being received from a first user terminal that is one of the plurality of user terminals, generate the slide show by combining a target content of the first user terminal and a related content which is related to the target content from among the contents stored in the storage.

2. The server of claim 1, wherein, in response to period-designation information being received from the first user terminal, the processor is further configured to determine a content generated or uploaded in the first user terminal during a period corresponding to the period-designation information from among contents transmitted from the first user terminal as the target content.

3. The server of claim 1, wherein, in response to period-designation information and moving route information being received from the first user terminal, the processor is further configured to generate the slide show by additionally including a content related to a moving route where the first user terminal moves during a period corresponding to the period-designation information from among the contents stored in the storage.

4. The server of claim 1, wherein the processor is further configured to determine the related content from among the contents stored in the storage based on at least one piece of information on the target content, and
wherein the at least one piece of information comprises at least one of information on text included in the target content, information on an image included in the target content, information on a time when the target content is generated or uploaded, and information on a location where the target content is generated or uploaded.

5. The server of claim 1, wherein, in response to the target content being a photo content, the processor determines a content corresponding to information on at least one of an object, a figure, and a background included in the photo content as the related content.

6. The server of claim 1, wherein, in response to text being included in the target content, the processor extracts a keyword from the text and determines a content corresponding to the extracted keyword as the related content.

7. The server of claim 1, wherein the processor is further configured to determine a content being generated in the location where the target content is generated and at a time in a predetermined range with respect to the time when the target content is generated as the related content based the information on the location where the target content and the time when the target content is generated.

8. The server of claim 1, wherein the processor is further configured to generate the slide show so that background music corresponding to the information on a location where at least one content constituting the slide show is generated and the keyword extracted from text included in the at least one content is played back concurrently with the slide show.

9. The server of claim 1, wherein the communication interface communicates with an external server, and
wherein the processor is further configured to retrieve a content related to the target content from the external server by using information on the target content and generate the slide show by additionally including the retrieved content.

10. The server of claim 1, wherein the server comprises a server which provides a social network service (SNS), and
wherein the contents stored in the storage are contents that users of the plurality of user terminals upload to the server through the SNS.

11. A method for generating a slide show of a server, the method comprising:
receiving and storing contents transmitted from a plurality of user terminals;
receiving a command to generate a slide show for sequentially displaying a plurality of slide images from a first user terminal that is one of the plurality of user terminals; and
generating the slide show by combining a target content of the first user terminal and a related content which is related to the target content from among pre-stored contents.

12. The method of claim 11, wherein, in response to period-designation information being received from the first user terminal, the generating of the slide show comprises determining a content generated or uploaded in the first user terminal during a period corresponding to the period-designation information from among the contents transmitted from the first user terminal as the target content.

13. The method of claim 11, wherein, in response to period-designation information and moving route information being received from the first user terminal, the generating of the slide show comprises generating the slide show by additionally including a content related to a moving route where the first user terminal moves during a period corresponding to the period-designation information from among the pre-stored contents.

14. The method of claim 11, wherein the generating of the slide show comprises determining the related content from among the pre-stored contents based on at least one piece of information on the target content, and
wherein the at least one piece of information comprises at least one of information on text included in the target content, information on an image included in the target content, information on a time when the target content is generated or uploaded, and information on a location where the target content is generated or uploaded.

15. The method of claim 11, wherein, in response to the target content being a photo content, the generating of the slide show comprises determining a content corresponding to information on at least one of an object, a figure, and a background included in the photo content as the related content.

16. The method of claim 11, wherein, in response to text being included in the target content, the generating of the slide show comprises extracting a keyword from the text and determining a content corresponding to the extracted keyword as the related content.

17. The method of claim 11, wherein the generating of the slide show comprises determining a content being generated in the location where the target content is generated and at a time in a predetermined range with respect to the time when the target content is generated as the related content based the information on the location where the target content and the time when the target content is generated.

18. The method of claim 11, wherein the generating of the slide show comprises generating the slide show so that background music corresponding to the information on a location where at least one content constituting the slide show is generated and the keyword extracted from text included in the at least one content is played back concurrently with the slide show.

19. The method of claim 11, wherein the generating of the slide show comprises retrieving a content related to the target content from the external server by using information on the target content and generating the slide show by additionally including the retrieved content.

20. A non-transitory computer-readable recording medium comprising a program for executing a method for generating a slide show of a server, the method comprising:
receiving and storing contents transmitted from a plurality of user terminals;
receiving a command to generate a slide show for sequentially displaying a plurality of slide images from a first user terminal that is one of the plurality of user terminals; and
generating the slide show by combining a target content of the first user terminal and an related content which is related to the target content.
